(19) United States
(12) Patent Application Publication
(10) Pub. No.: US 2024/0020203 A1
(43) Pub. Date: Jan. 18, 2024

(54) APPLICATION AWARE STORAGE VOLUMES AND SNAPSHOTS FOR ENHANCED MANAGEMENT AND PROCESS EFFICIENCY

(71) Applicant: Dell Products L.P., Round Rock, TX (US)

(72) Inventors: Balasundaram Govindan, Bangalore (IN); Sunil Kumar, Bangalore (IN); Arieh Don, Newton, MA (US); Ravi Prakash Reddy Mittamida, Bangalore (IN)

(21) Appl. No.: 17/812,827

(22) Filed: Jul. 15, 2022

(51) Int. Cl. G06F 11/14

(52) U.S. Cl. CPC G06F 11/1458; G06F 2201/84

(57) ABSTRACT

Application aware storage volumes and snapshots are disclosed. An application, such as a data protection application, can discover a mapping between an application and storage volumes. The mapping, represented as application metadata, can be written to the volume and/or to backups. The application metadata facilitates application management and allows different administrators to communicate more effectively.

### FIELD OF THE INVENTION

Embodiments of the present invention generally relate to computing-related management, including datacenter and application management. More particularly, at least some embodiments of the invention relate to systems, hardware, software, computer-readable media, and methods for application aware storage volumes and application aware data.

### BACKGROUND

Managing a datacenter and applications operating in the datacenter is crucial. In fact, the complexity of datacenter management is addressed, in part, by managing various aspects of the datacenter with specialized administrators. These administrators collectively share the responsibility of managing the applications operating in the datacenter. Each administrator focuses on a different aspect of the datacenter (or other computing environment) operations.

A storage administrator, for example, manages the underlying infrastructure such as storage arrays, storage volumes, and other storage infrastructure. An application administrator manages the applications and is responsible for ensuring that applications are consistent and can be accessed continuously. A SAN (Storage Area Network) administrator is responsible for managing the network and for connecting hosts with storage arrays. A database administrator may manage a database and may be a specialized application administrator. A host administrator is responsible for managing hosts or nodes operating in the datacenter.

Over time, many of these administrators experience issues that may need to be resolved with the help of other administrators. Each of these administrators, unfortunately, communicates their needs using different terminology. An application/database administrator uses terms such as the name of the application or the name of a database. Examples include “Seattle Sales Oracle DB” or “Boston Branch SQLDB”. A host administrator uses terms that relates to the storage volume names in an operating system such as drive “A” in Windows OS or/dks/t0d0s3r5 in Linux. A storage administrator may use array terminology such as “volume-00A” or the like.

The disparity in terminology impacts the ability to identify an issue and can adversely impact the time needed to resolve the issue. For example, an oracle database administrator may see a decrease in the transactions per second rate for the “Boston Branch SQLDB”. The database administrator will first need to determine which host storage devices are used (e.g., drive letter “x” and “y”) and communicate the issue to the host administrator. The host administrator will need to determine the storage array devices associated with these host OS storage devices (e.g., Vol-1 or Vol-2) and communicate this information to the storage administrator. Once this information is available, the storage administrator can investigate the performance issues identified by the database administrator. The inability to communicate more effectively and identify the potential source or cause of an issue impacts overall system performance and may impact user satisfaction.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of a datacenter that includes application aware storage;

FIG. 2 discloses aspects of generating and storing application metadata for enabling application aware storage;

FIG. 3 discloses aspects of application aware storage;

FIG. 4 discloses example application types to include in the application metadata; and

FIG. 5 discloses aspects of a computing device, system, or entity.

### DETAILED DESCRIPTION OF SOME EXAMPLE EMBODIMENTS

Embodiments of the present invention generally relate to application aware storage volumes or devices. More particularly, at least some embodiments of the invention relate to systems, hardware, software, computer-readable media, and methods for making storage volumes and backups application aware.

Embodiments of the invention make volumes to be application aware and facilitate communication between different types of datacenter administrators. An application aware volume (or device) allows different administrators (e.g., application, database, network, host, storage administrators) to communicate more efficiently. This is achieved by storing application metadata in the volume or drive itself. The application metadata, in one example, overcomes the disparity in terms used by the various administrators. The application metadata maps applications to storage volume. Thus, an issue at the application or database level can quickly identify the relevant storage volume, whether logical, virtual, or physical.

This allows, for example, communication between the storage administrator, the host administrator and/or the database administrator using, for example, the application name. The application metadata recorded on the volume or device may include application type, application name, and other application metadata such as size, encryption, or the like.

Datacenter operations involve the management of large numbers of applications, hosts, storage arrays, volumes, and the like. Each of these categories may involve administrators that use their own set of terms. It is evident that in such an environment, communication between a database administrator and a storage administrator may be complicated.

A database administrator may indicate that a particular database is experiencing a decrease in its transactions/second rate or experiencing another issue. The database administrator, however, may be unaware of which volumes are used to support the database. Application aware storage volumes allow a storage administrator to identify the relevant volumes more quickly, using for example the application name, so that the volume can be identified, and the issue can be resolved. More specifically, embodiments of the invention allow different administrators to understand each other more quickly while allowing the administrators to communicate using terms common to their responsibilities.

In a context of a datacenter, which may include large numbers of applications, hosts, and volumes, embodiments of the invention may allow root cause analysis (RCA) to be performed more quickly. An application aware storage volume or device can be quickly identified. This improves uptime and helps the datacenter comply with any service level agreements (SLAB).

In addition to applications used by users, a datacenter or other storage center also includes applications that are configured to protect data. Data is often protected by generating backups, clones, snapshot, replicas, or the like. The following discussion refers to a data protection application, which refers to various types of data protection applications including integrated copy data management software (iCDM), snap management application such as DELL AppSync, custom scripts, backup applications such as DELL Networker or the like. These data protection applications may be host applications.

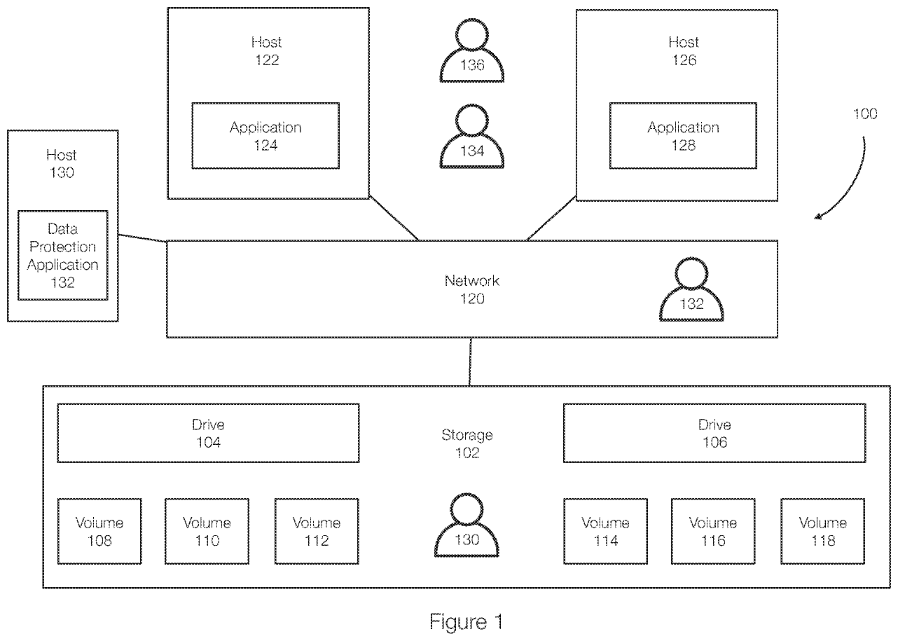

FIG. 1 discloses aspects of a datacenter and datacenter operations. FIG. 1 illustrates a datacenter 100 (e.g., the cloud, an on-premise system, an edge system). The datacenter 100 can provide a variety of different services. An entity may use the datacenter 100 to run their applications, to store/create backups of various types, to perform data protection operations, or the like. The datacenter 100 is associated with a host administrator 136, who is responsible for hosts in the datacenter represented by the hosts 122 and 126. The hosts 122 and 126 may be nodes (e.g., processor(s), memory, networking hardware) virtual machines running on a node, or the like.

The application administrator 134 is responsible for applications running in the datacenter 100, represented by the applications 124 and 128. The network administrator 132 is responsible for the network 120 (e.g., the storage area network or SAN) in the datacenter 100. The storage administrator 130 is responsible for the storage 102. The storage 102 includes multiple types of storage devices or arrays of storage devices, which are represented by the drives 104 and 106. Thus, the drives 104 and 106 may represent a storage array that includes multiple devices. In this example, the drive 104 may be associated with volumes 108, 110 and 112. Similarly, the device is associated with the volumes 114, 116, and 118.

The applications 124 and 128 may be of different types. The application 124, for example, may be a database application and the application 128 may be another application (e.g., email, work processing, image processing, web sales). The application 124 may be using the volumes 110 and 112. The application 128 may be using the volume 108 and 114.

FIG. 1 further illustrates a data protection application 132 operating on a host 130. The data protection application 132 may be configured to provide data protection services to the applications 124 and 128. This may include making backups of the data of the applications, which are stored on the drives 104 and 106 or specifically on the volumes 108, 110, 112, and 114 in this example. In some examples, the data protection application 132 may run on a production host such as the host 122 and/or the host 126 along with the applications thereon.

During operation, the data protection application 132 may discover the application 124. Discovery includes discovering the types of applications being protected and the storage layout of the applications. Discovery may occur multiple times. For example, changes to the storage layout or other configuration changes of the application 124 may be detected and managed. This allows the data protection application 132 to create snapshots, clones, backups, replicas, or the like (referred to generally herein as backups). The discovered information is an example of application metadata.

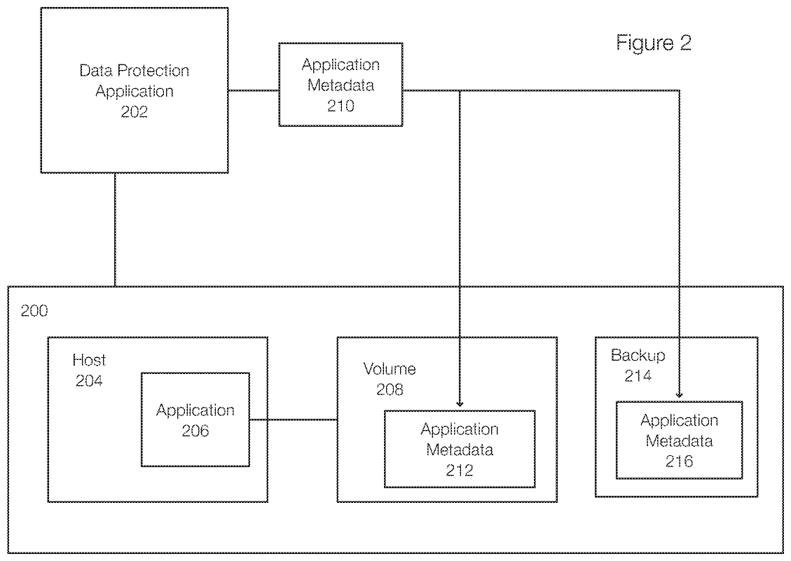

FIG. 2 discloses additional aspects of application aware storage volumes. FIG. 2 illustrates a data protection application 202 that is configured to perform data protection operations on the application 206. In this example, the application 202 is in a datacenter 200. In this example, the application 206 operates on a host 204 and is associated with a volume 208, which may be representative of multiple volumes.

The data protection application 202 may perform application discovery. The application metadata discovered by the data protection application may include, by way of example only and not limitation, application type, instance name, filesystem layout, operating system, drive, volume, or the like. The application metadata 210 may be generated by the data protection application 202 during discovery. In one example, the application metadata 210 maps the application 206 to the storage volume 208. The application metadata 210 is written to the volume 208 as the application metadata 212.

The application metadata 210 is also written to a backup 214 (e.g., clone, replica, copy, snapshot or other backup) as the application metadata 216. The data protection application 202 (or a host script or other engine) sends the application metadata 210 to the storage array/volume(s) of the application and/or to the storage array/volume(s) used by the data protection application 202. This allows a user (e.g., an administrator) to be aware of the application metadata 210 before and/or after a data protection operation, such as a restore operation.

As previously described, embodiments of the invention can be implemented in different data protection applications, different storage types, and different backup types (snapshots, backups, clones, replicas).

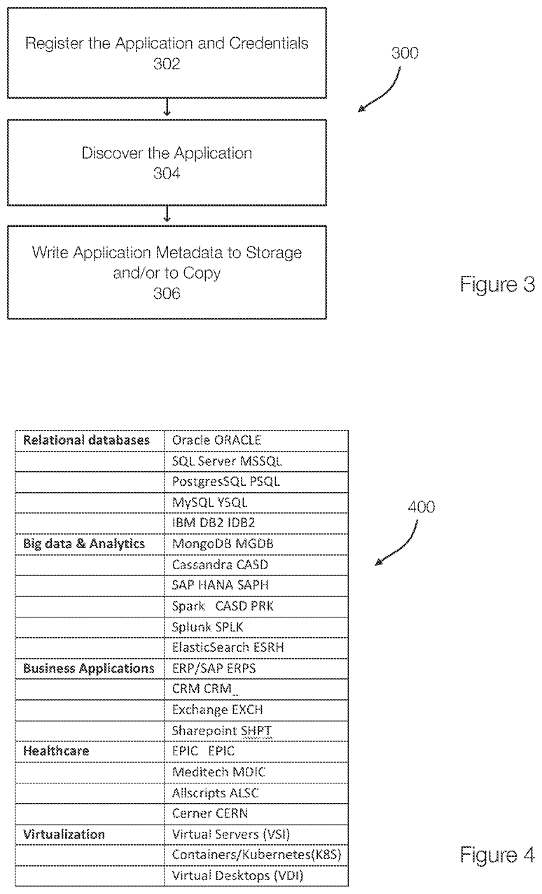

FIG. 3 discloses aspects of a method for application aware storage. In one example, an administrator may register 300 an application to be protected with the data protection application. This may include registering the storage array, the virtual center (e.g., vCenter in ESXi), the application host, and/or credentials in the assets of the data protection system. Once the application is registered, the data protection application discovers 304 the application. This may include discovering the application type (e.g., MS SQL server, Oracle, Exchange, PostgreSQL, SAP HANA), the filesystem layout (e.g., data in D:\ and log in E:\), application underlaying storage layout (e.g., data in volume 1, volume 2 and log in volume 3). The volume details may also be discovered in the respective arrays.

If the data protection is a copy management application (e.g., iCDM), the data protection application creates an application consistent copy of the application by freezing the application in the host and creating a copy of the underlying storage volumes in the storage array. The data protection application has a complete tree or map of the application to the underlying storage volumes after discovery is complete. Once discovery is complete, the application metadata is written 306 to the storage array and/or to the backup copy or copies.

Storage volumes may have various formats and the following discussion is by way of example only. In this example, the application metadata (or the application to storage volume mapping information) may be added as per-device information. The application metadata may be written to a specific field, such as a volume identifier. In one example, the application metadata may be converted to a string. If space for the string on the volume is a concern, then the string may have different formats. For example, a minimum application identifier and a maximum application identifier are two examples. Further, the string may be prefixed and/or postfixed such that the string can be recognized automatically, for example during a search. In one example, the prefix is “APS:” and the postfix is “$”.

By way of example, the minimum application identifier may be “Application type: OS Type: Instance Name”. For an Oracle database implementing a salesDB, the minimum application identifier may be:
“APS:Oracle:L:SalesDB$”.

This example includes an OS (operating system) name in the application metadata (L:Linux, E:ESXi, W:Windows, A:AIX). Other OS options may be available.

BY way of example, the maximum application identifier may be “Application Type: Deployment type: host name: Instance Name”. For an Oracle database implementing a salesDB, the maximum volume identifier may be:
“APS:Oracle:RAC:Lapplicationa:hostname:xyz:SalesDB$”.

In one example, the existing volume identifier of the volume, if any, is retrieved from the array for the volume. A check is performed to determine whether the application metadata can be appended to the existing volume identifier. This check is done in instances where the field used to store the volume identifier is limited in terms of size or available space (memory). If space is not an issue, all application metadata may be stored in the relevant field (or in another location). In any event, the available space may determine whether the minimum or maximum volume identifier is appended to the existing volume identifier.

In some examples, such as when multiple applications are deployed on a single volume, neither the maximum nor the minimum volume identifier may fit in the available space. In this case, the information may be merged. For example, in a situation that includes an MS SQL server DB1, an MS SQL server DB2, and an MS SQL server DB3 deployed on the same volume, the minimum volume identifier may be:
“APS:MSSERVER:W:DB1:DB2:DB3$”.

If this is not possible, the volume identifier may be changed to include only the application type. Thus, the minimum volume identifier may be:
“APS:Oracle$”.

In another example, the application metadata may be added to or appended to any existing volume identifier. More specifically, if a customer wrote “ABCD” as a device name in a situation where an Oracle DB names Marketing-June is deployed, the data protection application may retrieve the existing volume identifier and generate an identifier that reads as follows and is written to the device (this example includes a name the user gave the host):
“ABCD:APS:ORCL:Marketing-June:L:LQAM2011$”.

If a change in the application storage layout is detected, the volume identifiers may be updated. Further, the data protection application would also update the corresponding backups/snapshots/clones/bookmarks/replicas or the like.

FIG. 4 discloses aspect of example application metadata. The table 400 includes examples of application types and how they may be represented in the application metadata.

The application metadata will provide enhanced experience to the storage administrator and allows the storage administrator to understand the business context and the application deployed on the respective volumes. Storage administrators, network (e.g., SAN) administrators, backup administrators, and application administrators can communicate using the application name to resolve issues.

Storage admin, SAN admin, backup admin and application admin can communicate using the application name to resolve issues.

The application administrator can easily identify unused or deleted application volumes using the application name. The storage administrator can identify the application by the volume identifier and notify an application administrator of the respective application in various situations including when a volume in an array fails.

Embodiments of the invention provide other advantages. For example, the storage administrator can identify a problematic application in case a particular volume consumes lot of IO (Input/Output). A storage volume can be expended to an existing database. For example, a storage volume may not behave properly. The storage volume may begin sending a lot of IOs or sending encrypted IOs. Conventionally, this can be identified by stating that “vol x” is not behaving properly. Thus, the host administrator needs to say which host device name corresponds to vol x (e.g., the drive letter) and then ask the database administrator which application uses this drive letter. When the volume is application aware, the storage administrator can simply state that application name NE sales is not behaving properly.

The storage administrator can list the application copies by snapshot/clone/backup copies using the application metadata. For example, snapshots may conventionally be named “snapshot 1 of device 1”, “snapshot 2 of device 1”. When the snapshot is application aware, the snapshot name may be “snapshot 1 of NE sales”, snapshot 2 of NE sales”. The snapshot name is saved thus saved. More specifically, snapshots have a name that may reflect the time and date of the snapshot and this information should be retained. Thus, a snapshot name that is application aware may be “snapshot-2022-08-27 12:32 PM of NE sales”.

The storage administrator can generate the number of snapshots, number of clone and backup copies that exist for an application in the storage array. More specifically, it is possible to state that device 1 has four snapshots (snap1-snap4). When the snapshot is application aware, the storage administrator can say that “NE Sales has 4 snapshots”. Snapshots are often taken at a cadence and more important applications may have a higher cadence. One benefit of application aware snapshots is that the number of snapshots per application can be specified rather than knowing the number of snapshots per device and then having to determine which application is using that device.

Service level objectives (SLOB) for a set of application volumes can be increased. In this example, the host administrator does not need to translate from the OS device name to the storage array device number. For example, instead of assigning DIAMOND SLO to a storage group (list of devices) named SG1, the storage administrator will know that DIAMOND SLO is being assigned to “NE sales”. This allows the database administrator to tell the storage administrator to set DIAMOND SLO for “NE sales” and will not need to ask the host administrator to translate from OS device name to storage array device number.

Migrating an application along with snapshots can be facilitated using the application metadata. The storage administrator knows all of the devices used by the “NE sales” application. As a result, the storage administrator can migrate all of the devices using the application name.

By discovering the mapping between an application and storage volumes, this information (the application metadata) can be stored in the volumes (e.g., as the volume identifier). The application metadata can also be included or appended to each snapshot/clone/copy or other copies using data protection applications.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, data protection operations which may include, but are not limited to, data replication operations, IO replication operations, data read/write/delete operations, data deduplication operations, data backup operations, data restore operations, data cloning operations, data archiving operations, and disaster recovery operations. More generally, the scope of the invention embraces any operating environment in which the disclosed concepts may be useful.

At least some embodiments of the invention provide for the implementation of the disclosed functionality in existing platforms, examples of which include the Dell-EMC NetWorker and Avamar platforms and associated backup software, iDMC, DELL Appsync, and storage environments such as the Dell-EMC DataDomain storage environment. In general, however, the scope of the invention is not limited to any particular data backup platform or data storage environment.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment. Where a backup comprises groups of data with different respective characteristics, that data may be allocated, and stored, to different respective targets in the storage environment, where the targets each correspond to a data group having one or more particular characteristics.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data protection system components such as databases, storage servers, storage volumes (LUNs), storage disks, replication services, backup servers, restore servers, backup clients, and restore clients, for example, may likewise take the form of software, physical machines, containers, or virtual machines (VM), though no particular component implementation is required for any embodiment.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form.

As used herein, the term ‘backup’ is intended to be broad in scope. As such, example backups in connection with which embodiments of the invention may be employed include, but are not limited to, full backups, partial backups, clones, snapshots, copies, replicas, and incremental or differential backups.

It is noted that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

Following are some further example embodiments of the invention. These are presented only by way of example and are not intended to limit the scope of the invention in any way.

Embodiment 1. A method comprising: discovering a mapping between an application operating in a datacenter and storage volumes, wherein the mapping is stored in application metadata, writing the application metadata to the storage volumes associated with the application, and writing the application metadata to backups of the application.

Embodiment 2. The method of embodiment 1, wherein the backups include snapshots, clones, replicas, or copy data management copies.

Embodiment 3. The method of embodiment 1 and/or 2, wherein the application metadata includes an application name, an application type, a deployment type, a host name, an instance name, and/or an operating system.

Embodiment 4. The method of embodiment 1, 2, and/or 3, further comprising writing the application metadata as a volume identifier.

Embodiment 5. The method of embodiment 1, 2, 3, and/or 4, further comprising appending the application metadata to an existing volume identifier.

Embodiment 6. The method of embodiment 1, 2, 3, 4, and/or 5, further comprising identifying issues in the storage volumes using an application name to identify a volume in the storage volumes.

Embodiment 7. The method of embodiment 1, 2, 3, 4, 5, and/or 6, further comprising identifying unused or deleted application volumes by an application name.

Embodiment 8. The method of embodiment 1, 2, 3, 4, 5, 6, and/or 7, further comprising identifying the application using a volume identifier that stores the application metadata.

Embodiment 9. The method of embodiment 1, 2, 3, 4, 5, 6, 7, and/or 8, further comprising determining a number of backups using the application metadata.

Embodiment 10. The method of embodiment 1, 2, 3, 4, 5, 6, 7, 8, and/or 9, wherein the backups include copies of the storage volumes.

Embodiment 11. A method for performing any of the operations, methods, or processes, or any portion of any of these, or any combination thereof disclosed herein.

Embodiment 12. A non-transitory storage medium having stored therein instructions that are executable by one or more hardware processors to perform operations comprising the operations of any one or more of embodiments 1-11.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

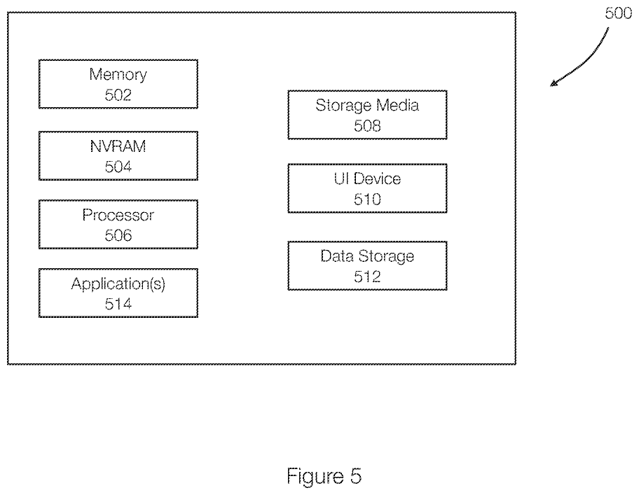

With reference briefly now to FIG. 5, any one or more of the entities disclosed, or implied, by the Figures, and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid-state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
discovering a mapping between an application operating in a datacenter and storage volumes, wherein the mapping is stored in application metadata;
writing the application metadata to the storage volumes associated with the application; and
writing the application metadata to backups of the application.

2. The method of claim 1, wherein the backups include snapshots, clones, replicas, or copy data management copies.

3. The method of claim 1, wherein the application metadata includes an application name, an application type, a deployment type, a host name, an instance name, and/or an operating system.

4. The method of claim 1, further comprising writing the application metadata as a volume identifier.

5. The method of claim 4, further comprising appending the application metadata to an existing volume identifier.

6. The method of claim 1, further comprising identifying issues in the storage volumes using an application name to identify a volume in the storage volumes.

7. The method of claim 1, further comprising identifying unused or deleted application volumes by an application name.

8. The method of claim 1, further comprising identifying the application using a volume identifier that stores the application metadata.

9. The method of claim 1, further comprising determining a number of backups using the application metadata.

10. The method of claim 1, wherein the backups include copies of the storage volumes.

11. A non-transitory storage medium having stored therein instructions that are executable by one or more hardware processors to perform operations comprising: discovering a mapping between an application operating in a datacenter and storage volumes, wherein the mapping is stored in application metadata;
writing the application metadata to the storage volumes associated with the application; and
writing the application metadata to backups of the application.

12. The non-transitory storage medium of claim 11, wherein the backups include snapshots, clones, replicas, or copy data management copies.

13. The non-transitory storage medium of claim 11, wherein the application metadata includes an application name, an application type, a deployment type, a host name, an instance name, and/or an operating system.

14. The non-transitory storage medium of claim 11, further comprising writing the application metadata as a volume identifier.

15. The non-transitory storage medium of claim 14, further comprising appending the application metadata to an existing volume identifier.

16. The non-transitory storage medium of claim 11, further comprising identifying issues in the storage volumes using an application name to identify a volume in the storage volumes.

17. The non-transitory storage medium of claim 11, further comprising identifying unused or deleted application volumes by an application name.

18. The non-transitory storage medium of claim 11, further comprising identifying the application using a volume identifier that stores the application metadata.

19. The non-transitory storage medium of claim 11, further comprising determining a number of backups using the application metadata.

20. The non-transitory storage medium of claim 11, wherein the backups include copies of the storage volumes.
